(19) United States
(12) Patent Application Publication
(10) Pub. No.: US 2025/0237328 A1
(43) Pub. Date: Jul. 24, 2025

(54) Toolless Adjustable Pipe Support

(71) Applicant: MIRO Industries, Inc., Heber City, UT (US)

(72) Inventors: GARY JR KUMMER, Orem, UT (US); RICHARD R. KNIGHT, Midway, UT (US); CHANCE SPENSKO, Heber City, UT (US); JASON REED HADDOCK, Heber City, UT (US); JARRETT ALAN WELCH, Herber City, UT (US); SAMUEL RICHARD ROBINS, Heber City, UT (US); KOLTEN POST, Heber City, UT (US); CRAIG DAVIS, Heber City, UT (US); JOHN NATHAN POST, Heber City, UT (US)

(73) Assignee: MIRO Industries, Inc., Heber City, UT (US)

(21) Appl. No.: 18/418,952

(22) Filed: Jan. 22, 2024

(51) Int. Cl. F16L 3/24

(52) U.S. Cl. CPC F16L 3/243

(57) ABSTRACT

A pipe support may include a first stanchion comprising a first aperture defined in the first stanchion and a second stanchion. The second stanchion may include a second aperture defined in the second stanchion and a locking slot defined in the second stanchion. The pipe support may also include a setting pin. The setting pin may include a first leg and a second leg. The first leg may engage with the first aperture and the second aperture, and the second leg may engage with the locking slot to lock the setting pin in an engaged state.

### TECHNICAL FIELD

The present disclosure relates generally to pipe supports. Specifically, the present disclosure relates to systems, devices, and methods for providing a toolless adjustable pipe support.

### BACKGROUND

Residential and commercial buildings and other structures are ubiquitously provided with utility services such as electrical, water, natural gas, telecommunications, and sewer, among other services. Consequently, infrastructure required to support these services as well as associated appliances and devices may be installed in the structures to provide these utility services throughout the structure. Natural gas pipes, electrical conduits, drainage pipes, and other infrastructure may be placed on a rooftop of the structure to allow for these infrastructure elements associated with, for example, appliances such as heating, ventilation, and air conditioning (HVAC) devices to be removed from the interior spaces of the structure. This locating of the infrastructure outside of the interior building space allows for more space inside the structure to be utilized. Further, these infrastructure elements may be placed on the rooftop of the structure to provide easy access to the infrastructure and any associated appliances by service professionals.

The infrastructure elements described above may be placed on and/or run along the roof of the structure and are often supported above the horizontal surface at intervals along their length by placing supporting mechanisms, like blocks of wood or other objects, between the horizontal surface and the infrastructure elements. When the temperature changes, the infrastructure elements such as the pipes may expand and contract and often the wood block or other support object may move with the infrastructure elements because, in part, of the large contact surface area and or the coefficient of friction between the block and the roof top and/or the infrastructure elements. Eventually, movement of the block against the roof combined with the weight of the infrastructure elements on the wood block or other support device may cause damage to the roof, resulting in leaks and requiring expensive roof repair. Even if the wood blocks or other support devices are secured to the roof using, for example, a number of fasteners, the fasteners and the wood block may deteriorate due to exposure to the environment, and the wood blocks may break loose from the infrastructure elements. This may, in turn, case damage to the infrastructure elements and/or the roof surface of the structure.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a top, front, right perspective view of a toolless, adjustable pipe support, according to an example of the principles described herein.

FIG. 2 illustrates a top, front, left perspective view of the toolless, adjustable pipe support, according to an example of the principles described herein.

FIG. 3 illustrates a top, rear, right perspective view of the toolless, adjustable pipe support, according to an example of the principles described herein.

FIG. 4 illustrates a top, rear, left perspective view of the toolless, adjustable pipe support, according to an example of the principles described herein.

FIG. 5 illustrates a top view of the toolless, adjustable pipe support, according to an example of the principles described herein.

FIG. 6 illustrates a bottom view of the toolless, adjustable pipe support, according to an example of the principles described herein.

FIG. 7 illustrates a front side view of the toolless, adjustable pipe support, according to an example of the principles described herein.

FIG. 8 illustrates a rear side view of the toolless, adjustable pipe support, according to an example of the principles described herein.

FIG. 9 illustrates a left side view of the toolless, adjustable pipe support, according to an example of the principles described herein.

FIG. 10 illustrates a right side view of the toolless, adjustable pipe support, according to an example of the principles described herein.

FIG. 11 illustrates a front, right, plane view of the toolless, adjustable pipe support, according to an example of the principles described herein.

FIG. 12 illustrates a front, right, perspective view of the toolless, adjustable pipe support of FIG. 1 including a roller located at a different location with respect to FIG. 1, according to an example of the principles described herein.

FIG. 13 illustrates a rear side, left, perspective view of the toolless, adjustable pipe support of FIG. 1 including a roller located at a different location with respect to FIG. 1, according to an example of the principles described herein.

FIG. 14 illustrates a front, right, perspective view of the toolless, adjustable pipe support of FIG. 1 with a roller removed with respect to FIG. 1, according to an example of the principles described herein.

FIG. 15 illustrates a rear side, left, perspective view of the toolless, adjustable pipe support of FIG. 1 with a roller removed with respect to FIG. 1, according to an example of the principles described herein.

FIG. 16 illustrates a perspective view of the roller of the toolless, adjustable pipe support, according to an example of the principles described herein.

FIG. 17 illustrates a front plane view of the roller of the toolless, adjustable pipe support, according to an example of the principles described herein.

FIG. 18 illustrates a side view of the roller of the toolless, adjustable pipe support, according to an example of the principles described herein.

FIG. 19 illustrates a perspective view of a setting pin associated with the roller of the toolless, adjustable pipe support, according to an example of the principles described herein.

### DESCRIPTION OF EXAMPLE EMBODIMENTS

### Overview

There may exist a number of types of other infrastructure element-supporting mechanisms that may include a substantially planar-bottomed base and a pipe supporting structure rising from the base that distributes the weight of the pipe over the base and, therefore, over the area of the roof in contact with the base. However, these other infrastructure element-supporting mechanisms may not be able to address the expansion and contraction of the infrastructure elements such as pipes, as temperatures change. Further, the other infrastructure element-supporting mechanisms may be bulky and may require tools for installation and/or adjustment. This significantly increases the complexity, time, and expense of installing both the infrastructure element-supporting mechanisms and/or the infrastructure (e.g., the natural gas pipes, electrical conduits, drainage pipes, and other infrastructure, along with the appliances such as the HVAC devices that may be placed on a rooftop of the structure) the infrastructure element-supporting mechanisms are to support.

Further, other supporting elements may be expensive, especially where the supporting devices include or incorporate coupling devices and threaded vertical supports. These other supporting elements may also be disadvantaged by complexity and may be difficult to install along the surface of the roof of the structure. Yet another issue with these other supporting elements is that their mechanical strength may be limited for their weight.

Therefore, there exists a need for a versatile infrastructure support device that is capable of easily distributing the load of the infrastructure elements over the surface of the roof without suffering from the above-mentioned shortfalls and disadvantages of other infrastructure element-supporting mechanisms.

This disclosure describes a pipe support for use in supporting the infrastructure elements described herein. The pipe support does not require the use of any tools to install or adjust the pipe support. A setting pin including a first leg and a second leg may support a seat on which the infrastructure elements may be seated. The seat may include, for example, a roller that may couple with the first leg of the setting pin. The first leg engages with one of a plurality of first apertures defined in a first stanchion and one of a plurality of second apertures defined in a second stanchion. Further, the second leg of the setting pin may engage with a locking slot defined in the second stanchion to lock the setting pin in an engaged state with the pipe support.

Examples described herein provide a pipe support may include a first stanchion and a second stanchion. The first stanchion may include a first aperture defined in the first stanchion. The second stanchion may include a second aperture defined in the second stanchion, and a locking slot defined in the second stanchion. The pipe support may further include a setting pin. The setting pin may include a first leg and a second leg. The first leg may engage with the first aperture and the second aperture. The second leg may engage with the locking slot to lock the setting pin in an engaged state with the second stanchion.

The pipe support may further include a roller coupled to the first leg of the setting pin. The pipe support may further include a base coupled to at least one of the first stanchion or the second stanchion.

The first aperture may include a plurality of first apertures defined in the first stanchion. Further, the second aperture may include a plurality of second apertures defined in the second stanchion. The plurality of first apertures and the plurality of second apertures may be defined at increments along a length of the first stanchion and the second stanchion, respectively. The increments may be defined based on a unit of measurement. The pipe support may further include indicia located juxtaposition the increments. The indicia represent the increments.

The locking slot may include a plurality of locking slots defined in the second stanchion. The plurality of locking slots may be defined at increments along a length of the second stanchion. The increments may be defined based at least in part on locations of the plurality of first apertures and the plurality of second apertures. The locking slots may each include a first surface extending from an opening of the locking slot, a second surface extending from the opening of the locking slot opposite the first surface, and a seating surface formed in a terminus of the locking slot. A distance between the first surface and the second surface may be less than a width of the seating surface. The first surface and the second surface may retain the second leg of the setting pin within the seating surface formed in the terminus of the locking slot.

Examples described herein also provide a pipe support including a first stanchion including a first aperture defined in the first stanchion. The pipe support may also include a second stanchion including a second aperture defined in the second stanchion, and a locking slot defined in the second stanchion.

The pipe support may further include a setting pin. The setting pin may include a first leg to engage with the first aperture and the second aperture and a second leg to engage with the locking slot to lock the setting pin in an engaged state. Further, the pipe support may include a roller coupled to the first leg of the setting pin.

The pipe support may further include a base coupled to at least one of the first stanchion or the second stanchion. The first aperture may include a plurality of first apertures defined in the first stanchion. The second aperture may include a plurality of second apertures defined in the second stanchion. The plurality of first apertures and the plurality of second apertures may be defined at increments along a length of the first stanchion and the second stanchion, respectively. The increments are defined based on a unit of measurement. The pipe support may further include indicia located juxtaposition the increments, the indicia representing the increments.

The locking slot may include a plurality of locking slots defined in the second stanchion. The plurality of locking slots may be defined at increments along a length of the second stanchion. The increments may be defined based at least in part on locations of the plurality of first apertures and the plurality of second apertures.

The locking slot may include a first surface extending from an opening of the locking slot, a second surface extending from the opening of the locking slot opposite the first surface, and a seating surface formed in a terminus of the locking slot. A distance between the first surface and the second surface is less than a width of the seating surface. The first surface and the second surface retain the second leg of the setting pin within the seating surface formed in the terminus of the locking slot.

Additionally, the techniques described in this disclosure may be performed as a method and/or by a system having non-transitory computer-readable media storing computer-executable instructions that, when executed by one or more processors, performs the techniques described above.

### Example Embodiments

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

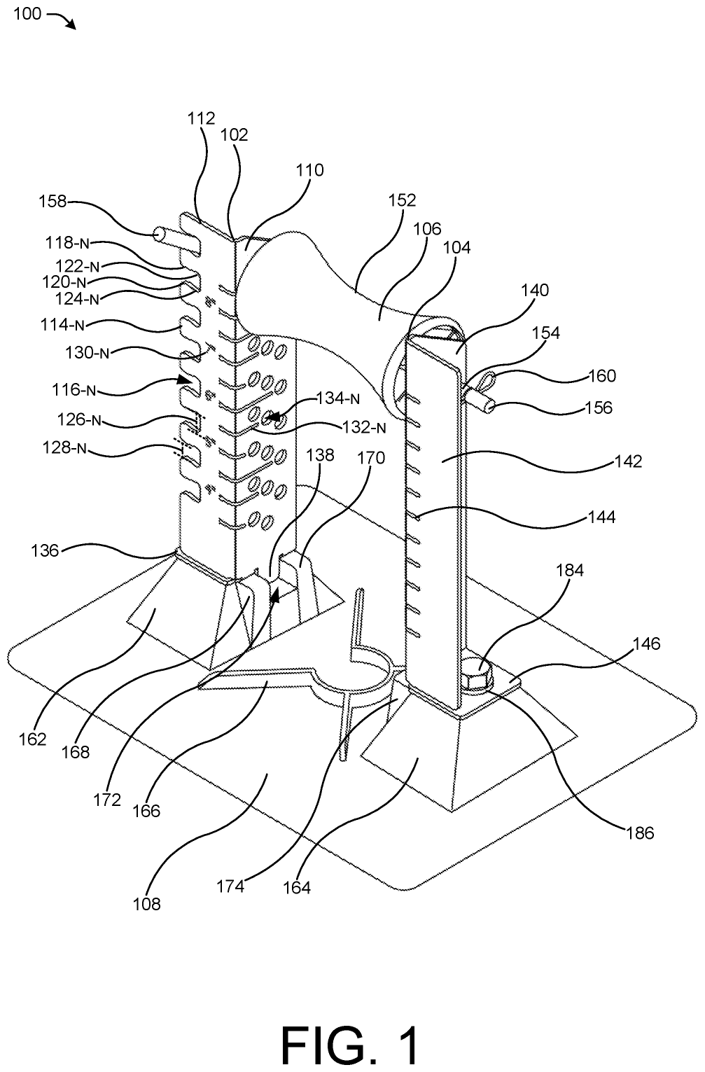

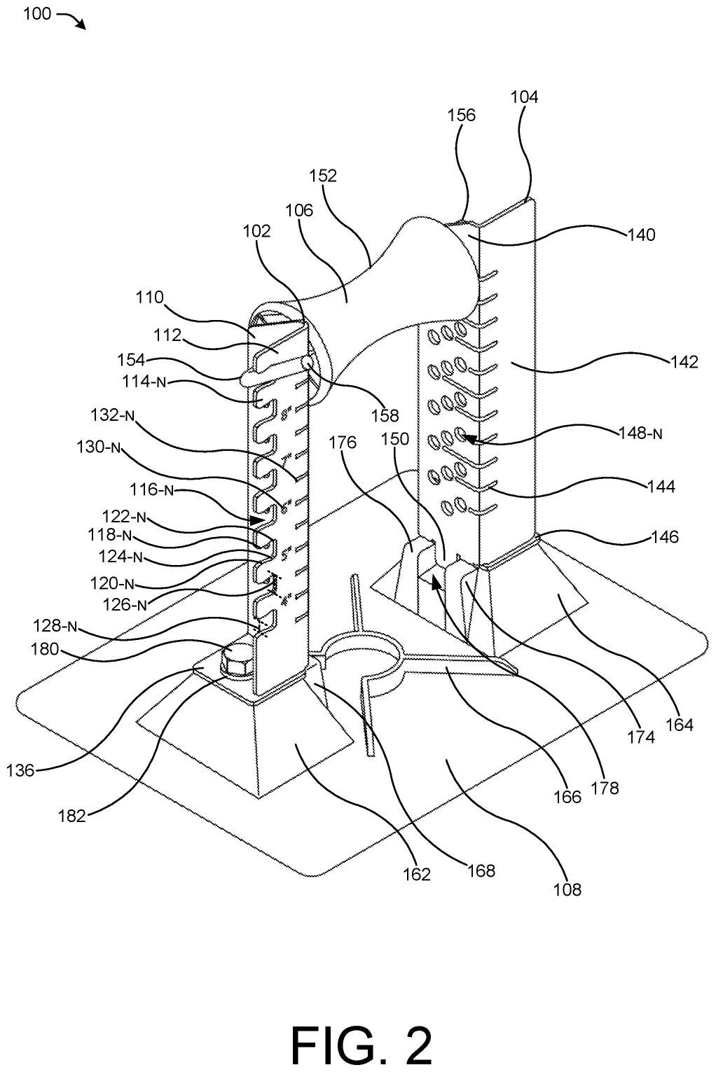

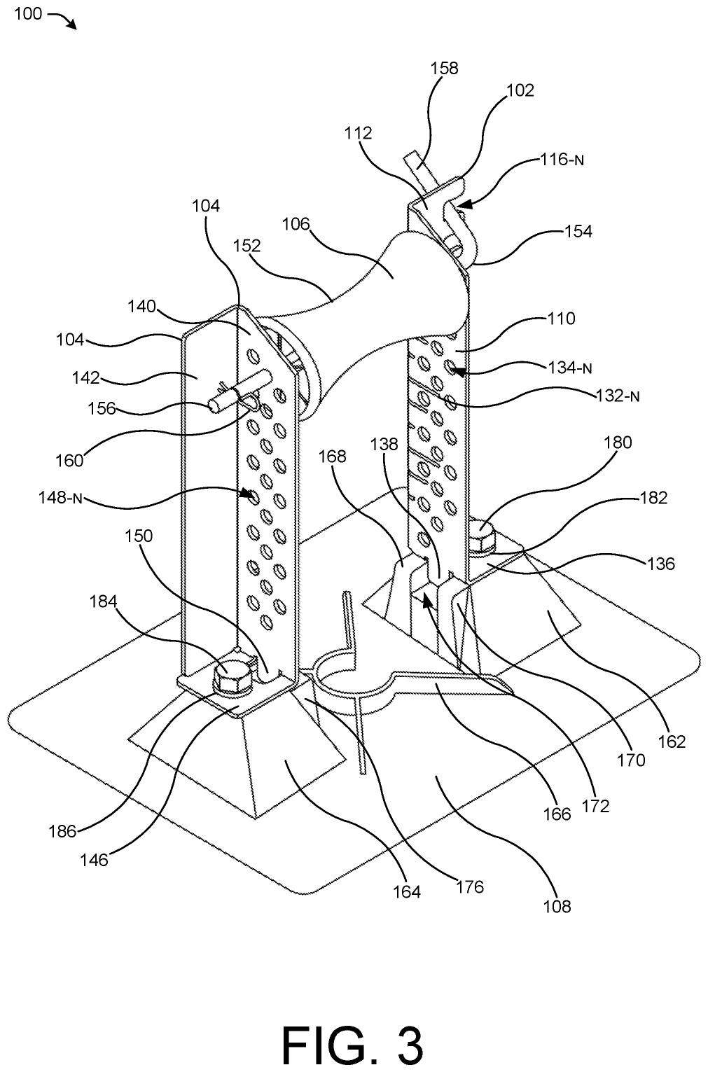

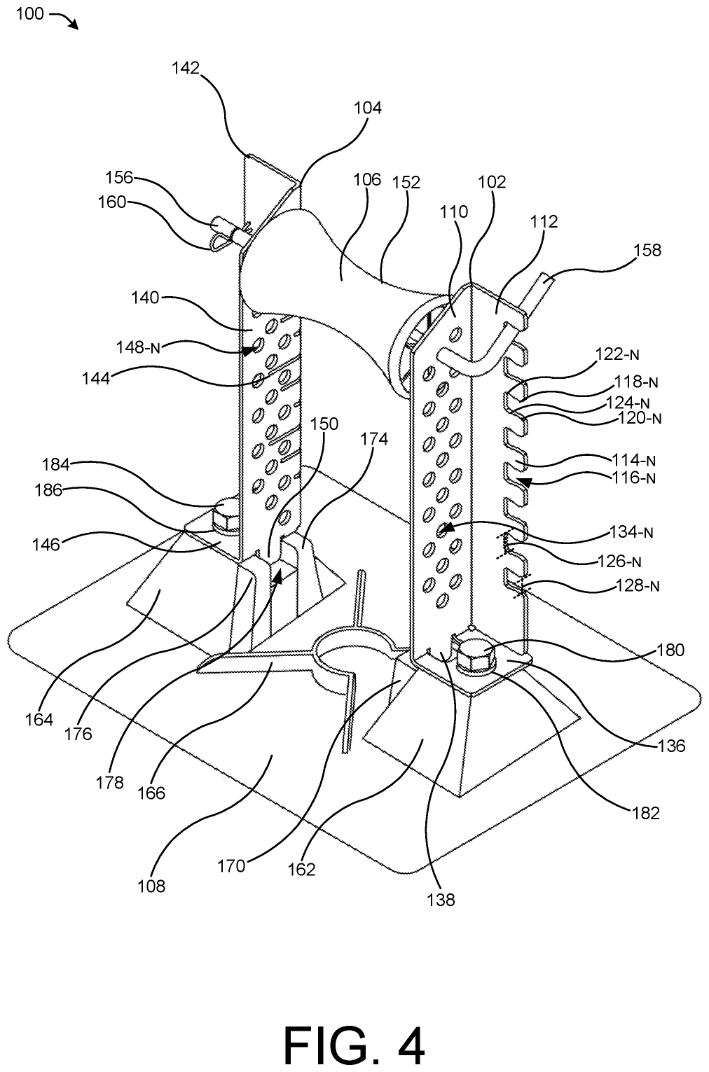

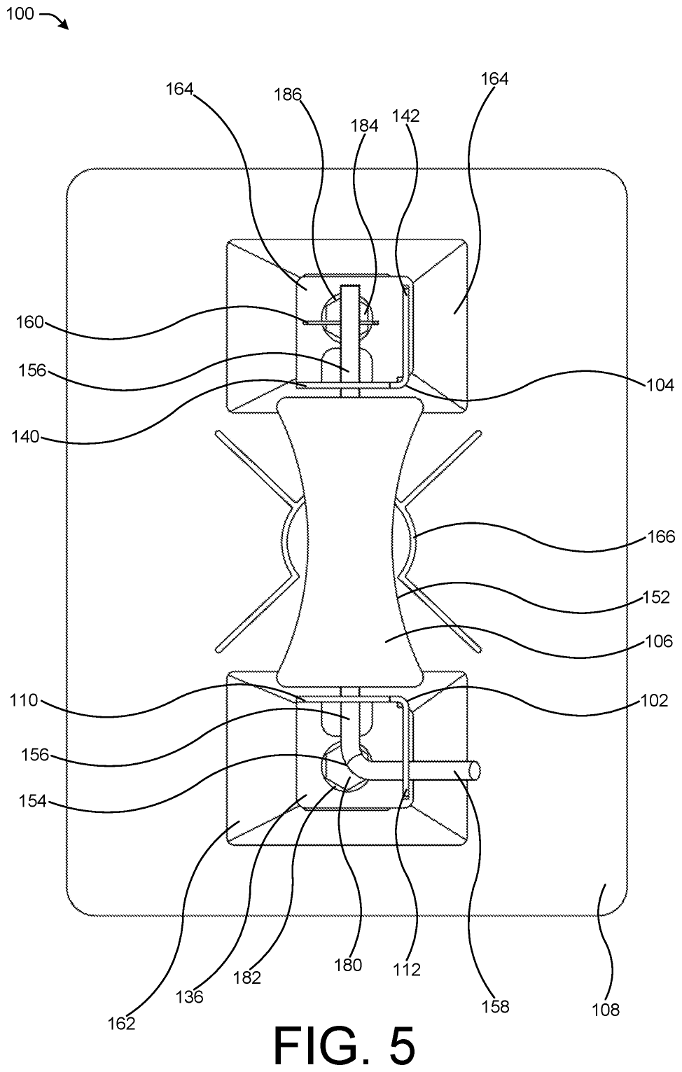

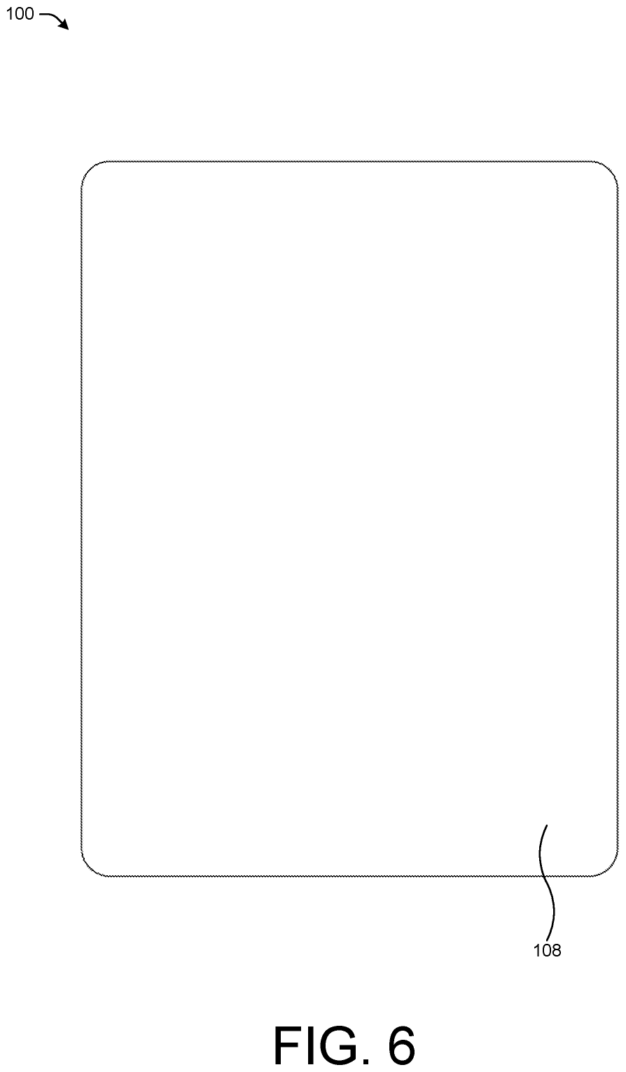

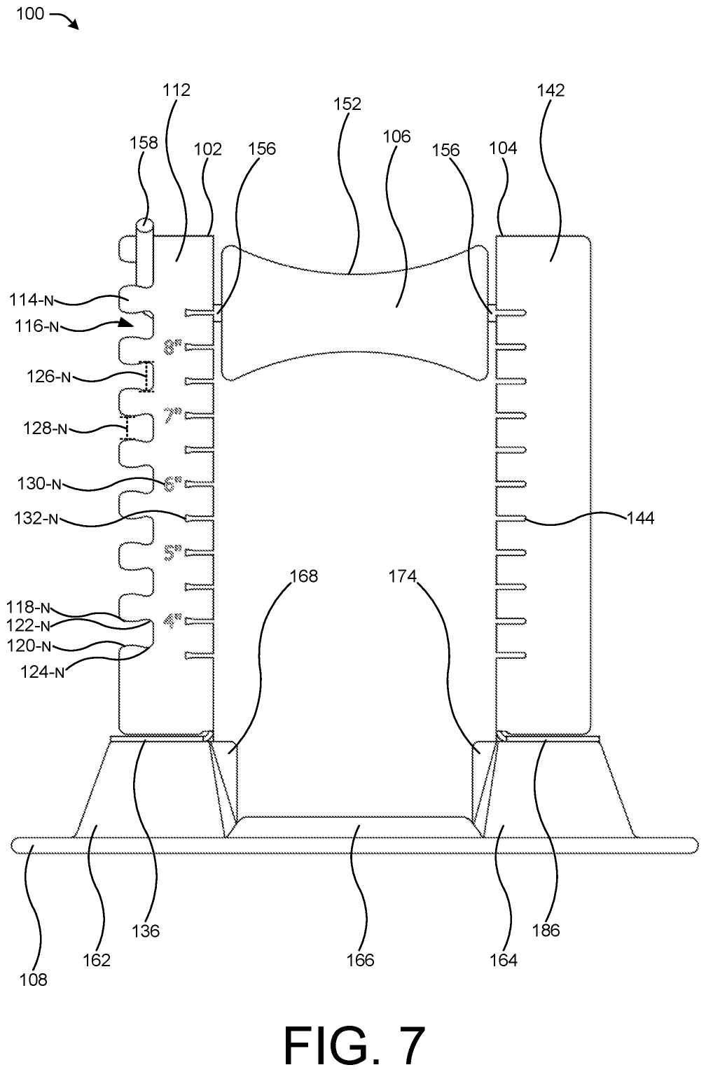

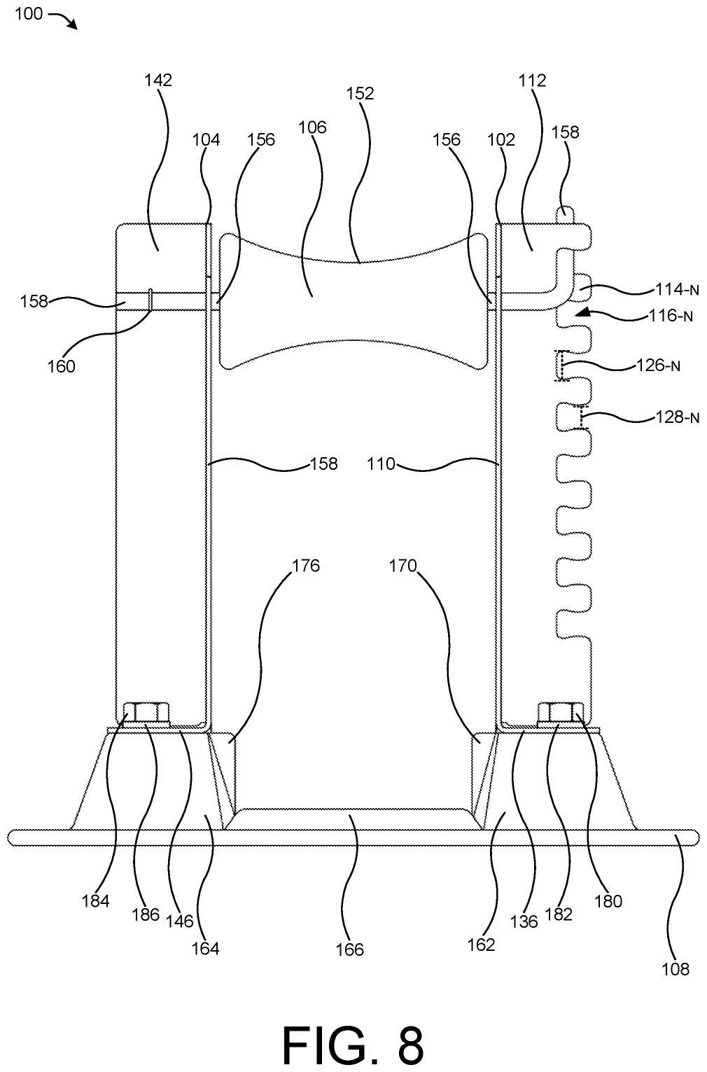

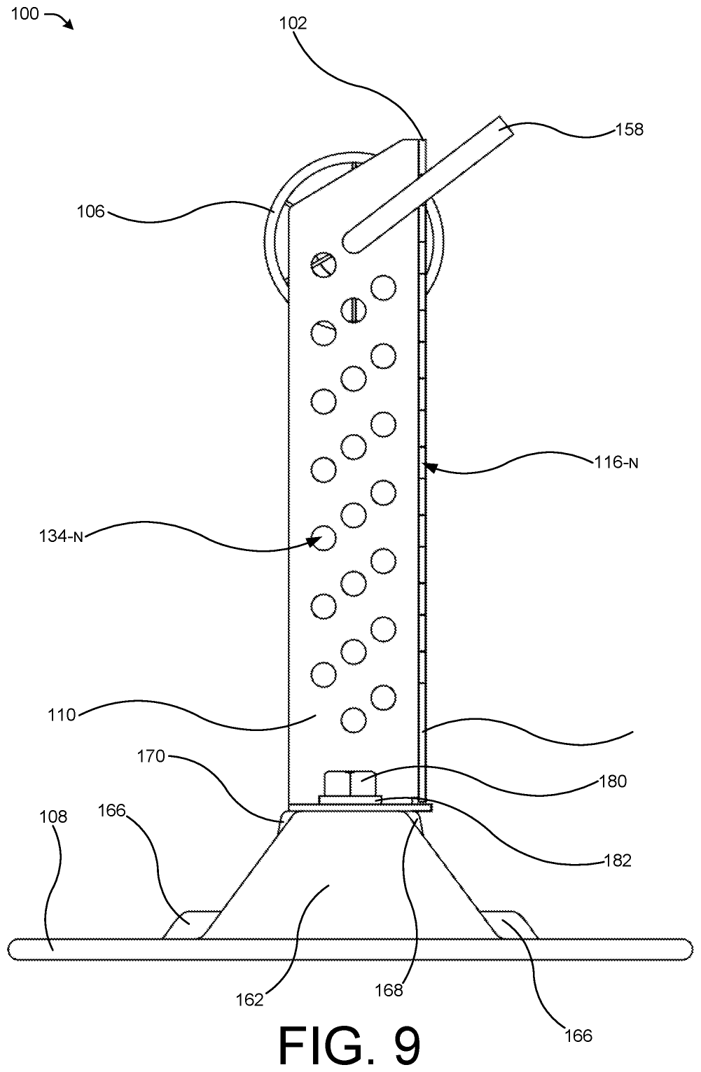

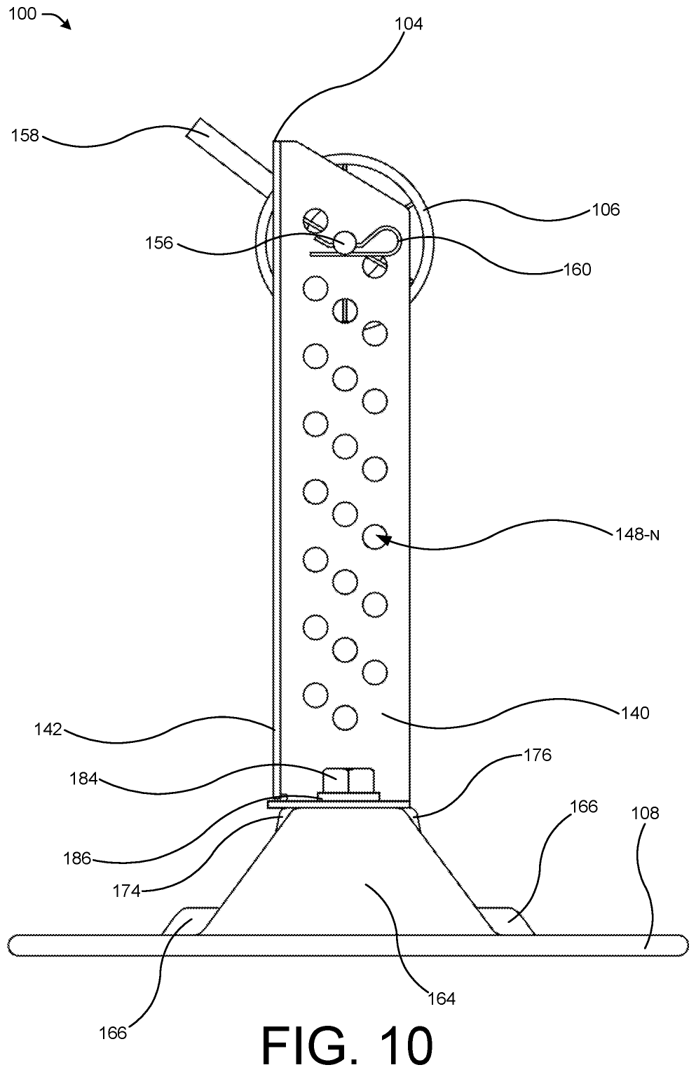

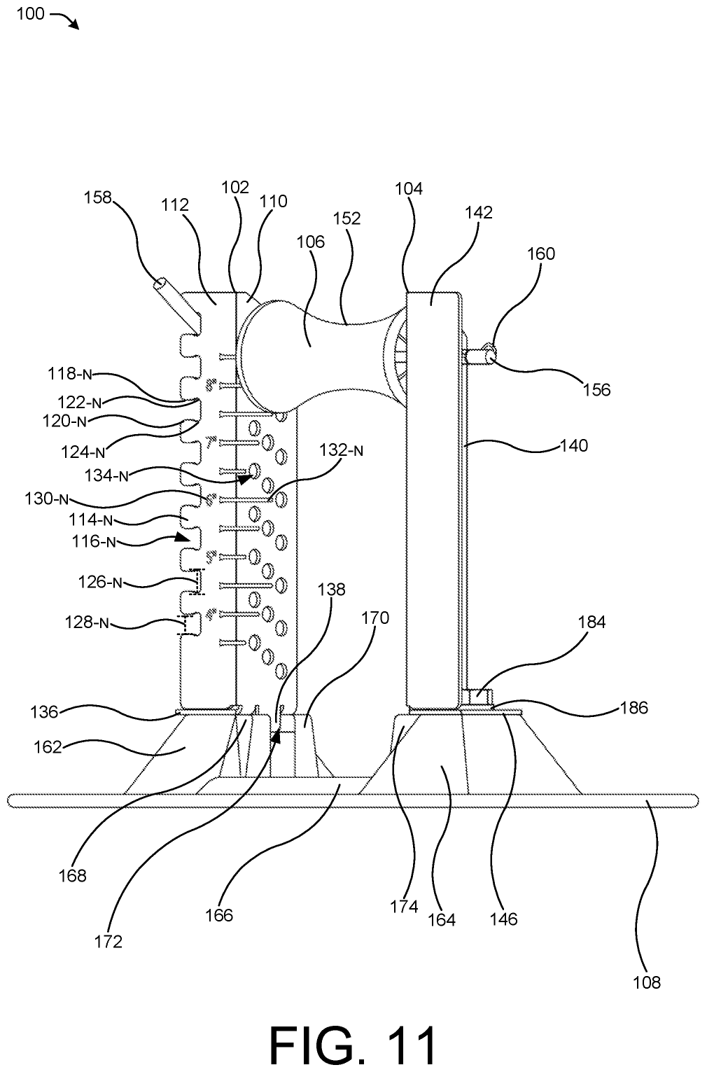

Examples will now be described in connection with FIGS. 1 through 19. FIGS. 1 through 19 depict several elements of a toolless, adjustable pipe support 100. Throughout the description, the toolless, adjustable pipe support 100 may be referred to as a pipe support 100. FIG. 1 illustrates a top, front, right perspective view of a toolless, adjustable pipe support 100, according to an example of the principles described herein. FIG. 2 illustrates a top, front, left perspective view of the toolless, adjustable pipe support 100, according to an example of the principles described herein. FIG. 3 illustrates a top, rear, right perspective view of the toolless, adjustable pipe support 100, according to an example of the principles described herein. FIG. 4 illustrates a top, rear, left perspective view of the toolless, adjustable pipe support 100, according to an example of the principles described herein. FIG. 5 illustrates a top view of the toolless, adjustable pipe support 100, according to an example of the principles described herein. FIG. 6 illustrates a bottom view of the toolless, adjustable pipe support 100, according to an example of the principles described herein. FIG. 7 illustrates a front side view of the toolless, adjustable pipe support 100, according to an example of the principles described herein. FIG. 8 illustrates a rear side view of the toolless, adjustable pipe support 100, according to an example of the principles described herein. FIG. 9 illustrates a left side view of the toolless, adjustable pipe support 100, according to an example of the principles described herein. FIG. 10 illustrates a right side view of the toolless, adjustable pipe support 100, according to an example of the principles described herein. FIG. 11 illustrates a front, right, plane view of the toolless, adjustable pipe support 100, according to an example of the principles described herein.

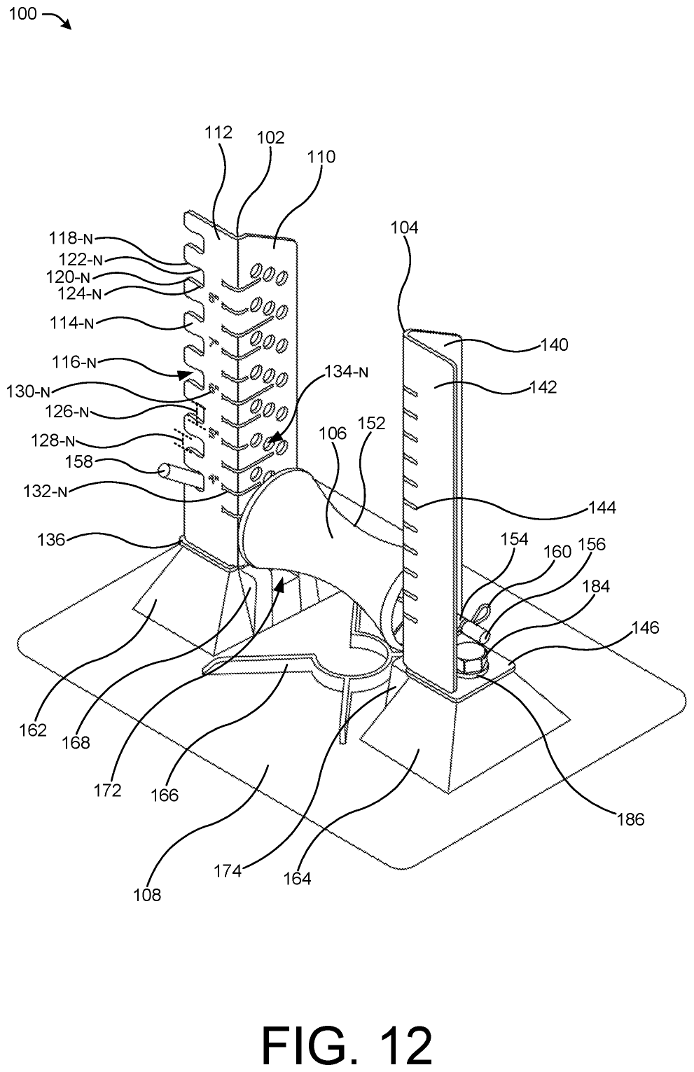

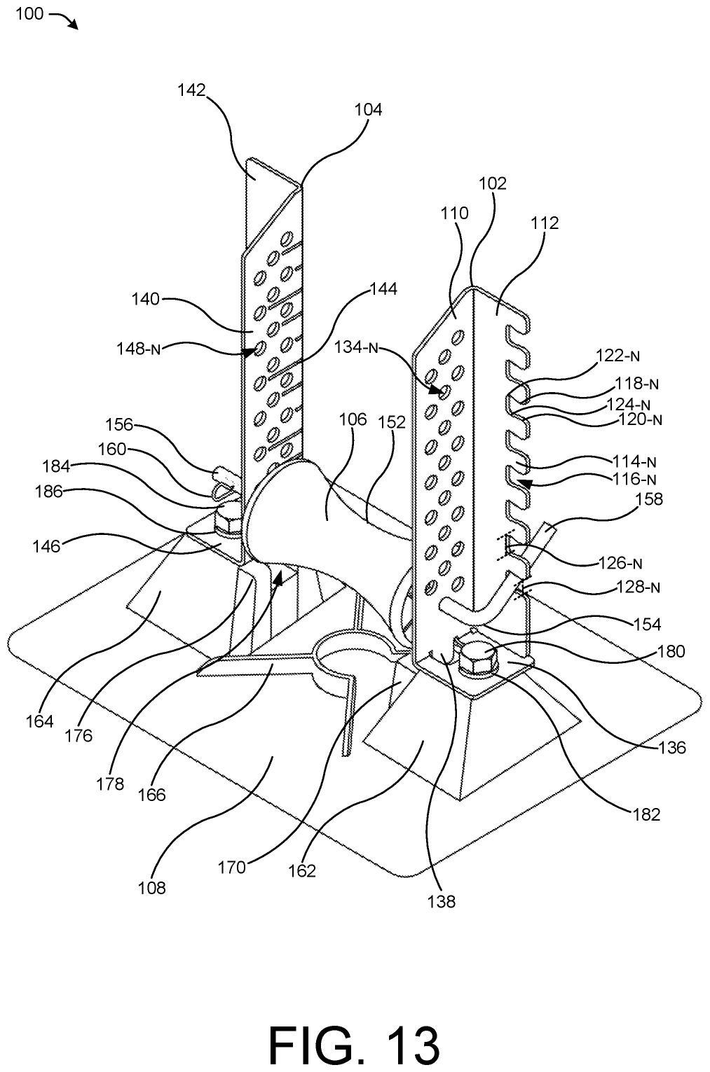

FIG. 12 illustrates a front, right, perspective view of the toolless, adjustable pipe support 100 of FIG. 1 including a roller 106 located at a different location with respect to FIG. 1, according to an example of the principles described herein. FIG. 13 illustrates a rear side, left, perspective view of the toolless, adjustable pipe support 100 of FIG. 1 including the roller 106 located at a different location with respect to FIG. 1, according to an example of the principles described herein.

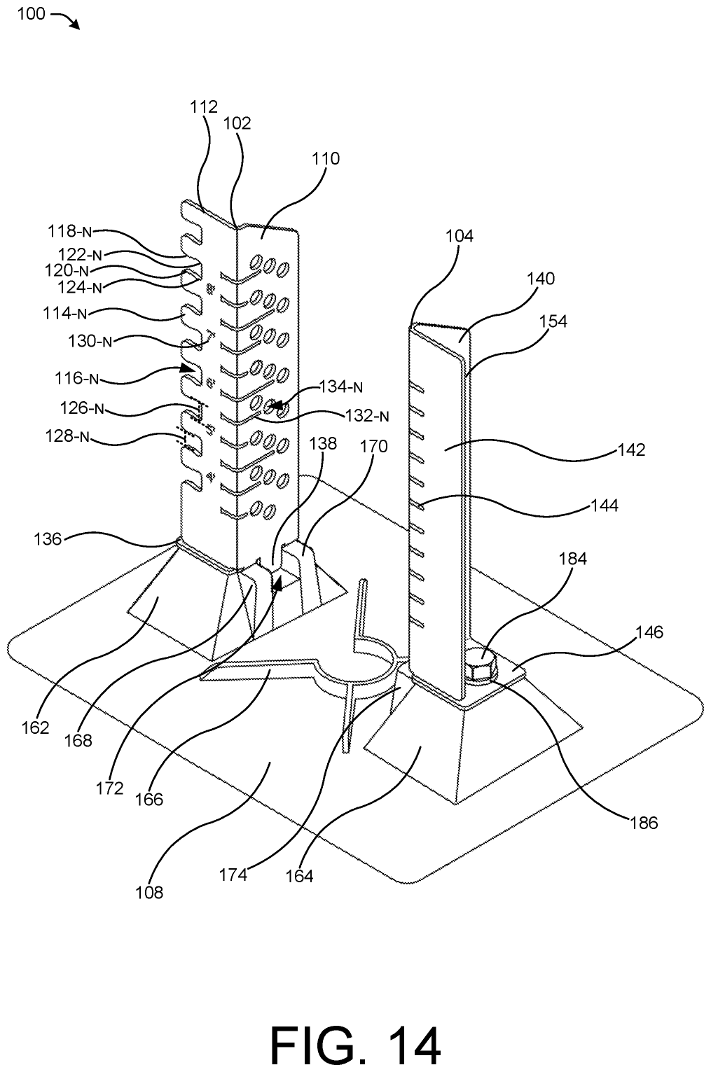

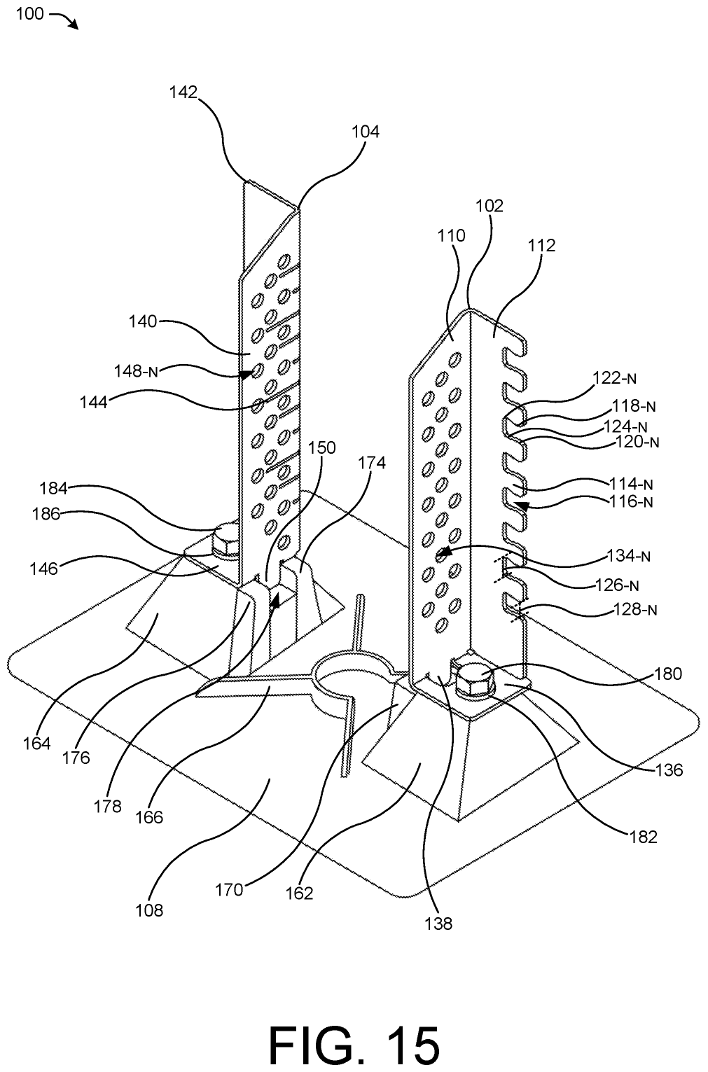

FIG. 14 illustrates a front, right, perspective view of the toolless, adjustable pipe support 100 of FIG. 1 with the roller 106 removed with respect to FIG. 1, according to an example of the principles described herein. FIG. 15 illustrates a rear side, left, perspective view of the toolless, adjustable pipe support 100 of FIG. 1 with the roller 106 removed with respect to FIG. 1, according to an example of the principles described herein.

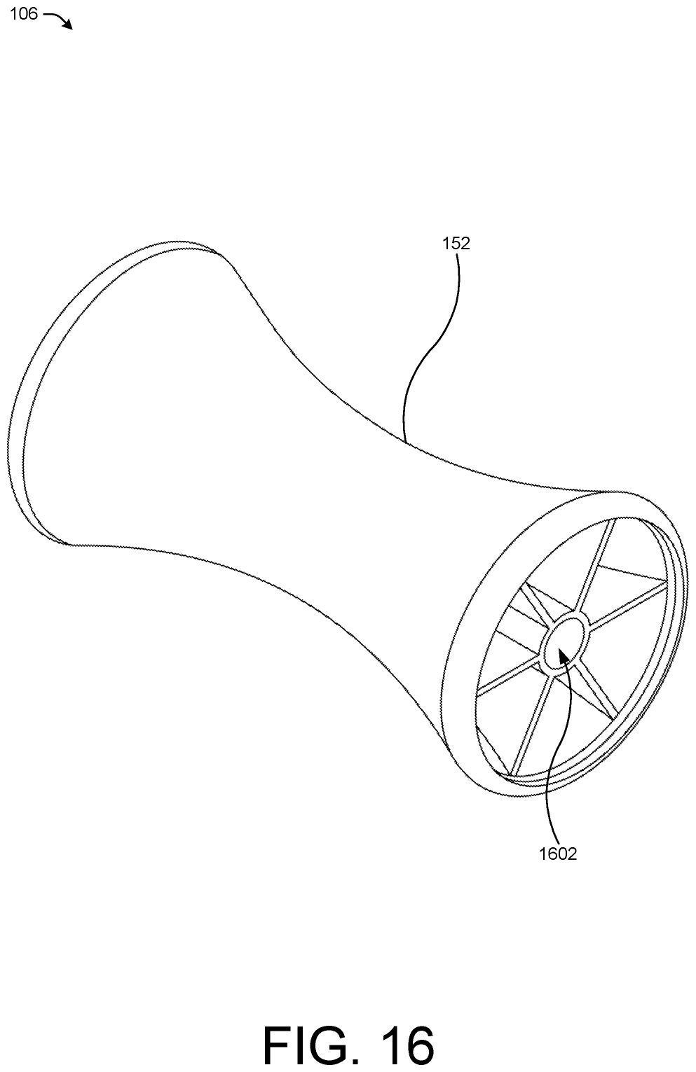

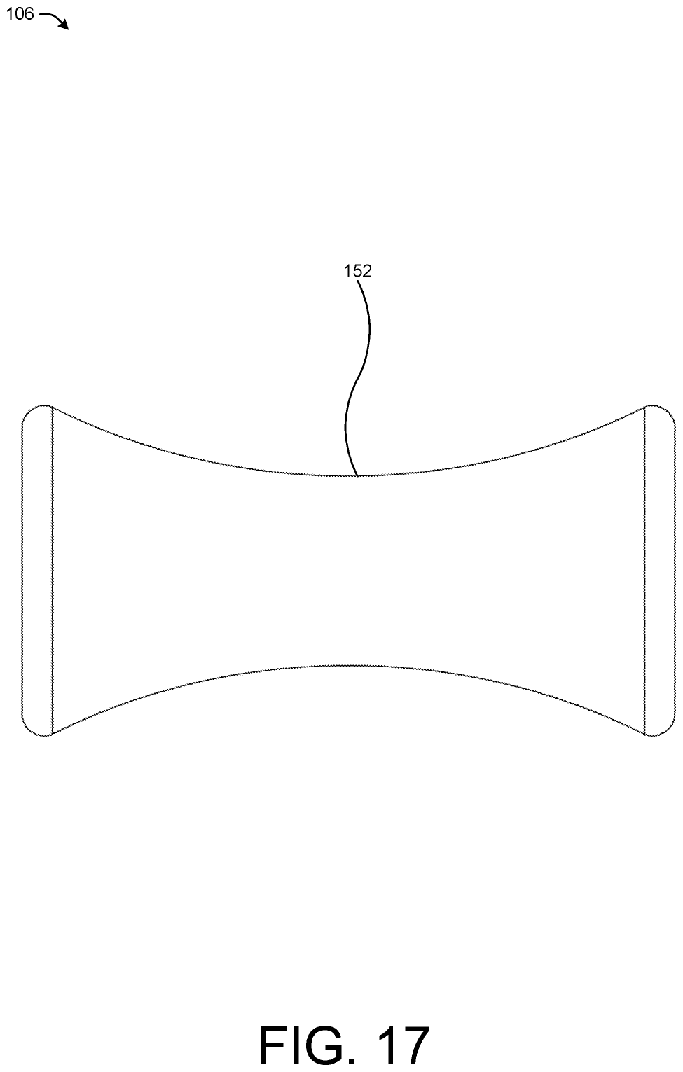

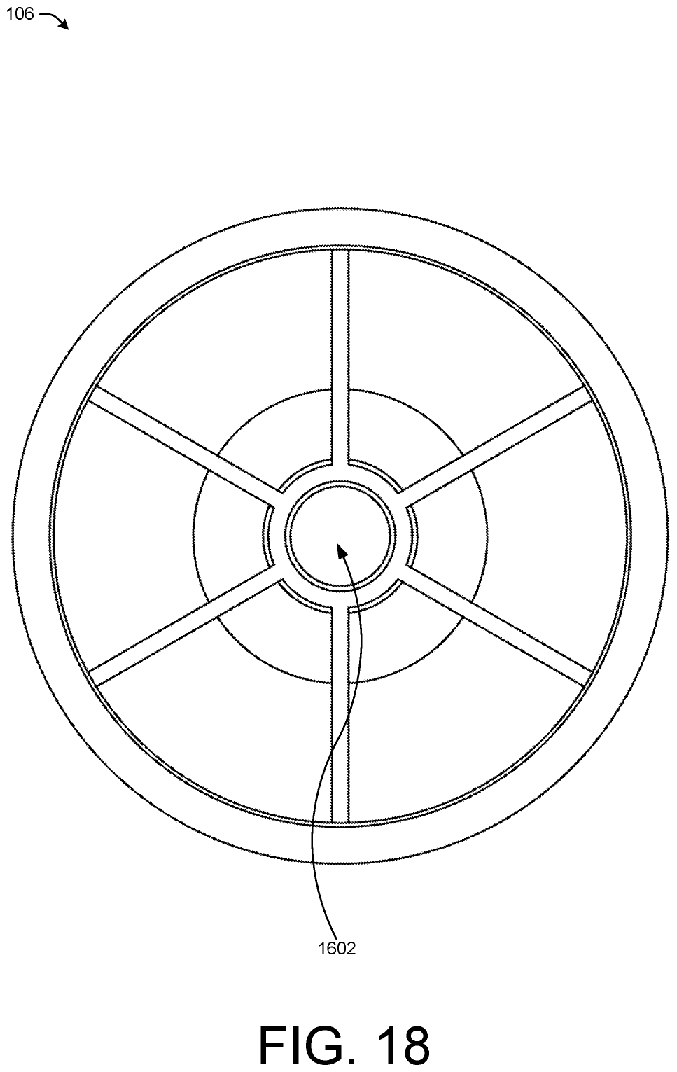

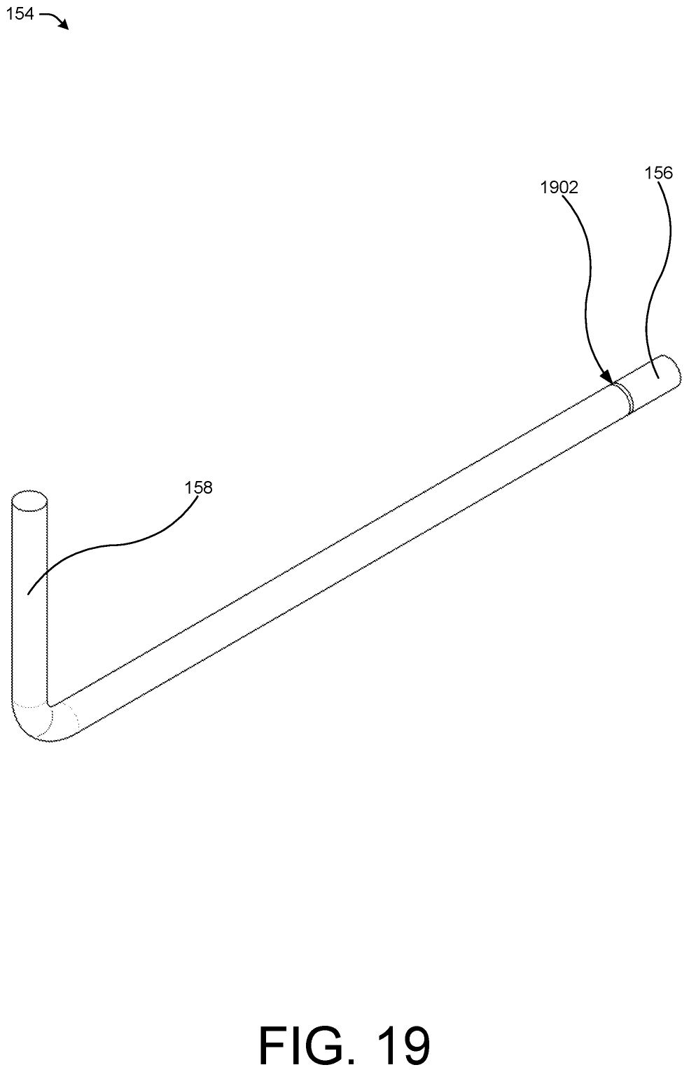

FIG. 16 illustrates a perspective view of the roller 106 of the toolless, adjustable pipe support 100, according to an example of the principles described herein. FIG. 17 illustrates a front plane view of the roller 106 of the toolless, adjustable pipe support 100, according to an example of the principles described herein. FIG. 18 illustrates a side view of the roller 106 of the toolless, adjustable pipe support 100, according to an example of the principles described herein. Finally, FIG. 19 illustrates a perspective view of a setting pin 154 associated with the roller 106 of the toolless, adjustable pipe support 100, according to an example of the principles described herein.

The toolless, adjustable pipe support 100 as depicted in FIGS. 1 through 15 may include a first stanchion 102 and a second stanchion 104. The toolless, adjustable pipe support 100 may further include a roller 106 that may be adjustably coupled with the first stanchion 102 and a second stanchion 104 through the adjustment of a setting pin 154 that is used to mount the roller 106 to the first stanchion 102 and a second stanchion 104. Further, the first stanchion 102 and a second stanchion 104 may be coupled to a base 108 to support the toolless, adjustable pipe support 100. Each of these elements of the toolless, adjustable pipe support 100 will now be described in more detail in turn.

The first stanchion 102 may include a first panel 110 and a second panel 112 formed approximately perpendicularly to the first panel 110. Further, the first stanchion 102 may include a first stanchion base 136 to couple the first stanchion 102 to the base 108. Still further, the first stanchion 102 may include a first tab 138 used to orient and secure the first stanchion 102 to the base 108. In one example, the first panel 110, the second panel 112, the first stanchion base 136, and the first tab 138 may be monolithically formed form a single piece of material such as a metal or metal alloy sheet that has been cut, bent, or otherwise formed in the shape depicted in FIGS. 1 through 15. The first panel 110, the second panel 112, and the first stanchion base 136 may be perpendicular with respect to one another in order to form a structurally rigid, weight bearing pipe support 100. The first tab 138 may extend from the bottom of the first stanchion 102 in order to engage with the base 108 as will be described in more detail herein.

The first panel 110 may include at least one first stanchion aperture 134-N (where N is any integer greater than or equal to 1) defined in the first panel 110 of the first stanchion 102. As depicted in FIGS. 1 through 15, a plurality of first stanchion apertures 134-N may be defined in the first panel 110. Further, a described herein in more detail, the location of the plurality of first stanchion apertures 134-N may be defined based on an increment of distance along a length of the first stanchion 102 in order to allow for the roller 106 to be coupled to the first stanchion 102 via the setting pin 154 at the increment of distance. In one example, the increments may be defined based on a unit of measurement such as inches or millimeters.

The second panel 112 of the first stanchion 102 may include at least one locking slot 116-N (where N is any integer greater than or equal to 1) defined in the second panel 112 of the first stanchion 102. As depicted in FIGS. 1 through 15, a plurality of locking slots 116-N may be defined in the second panel 112. Further, a described herein in more detail, the location of the plurality of locking slots 116-N may be defined based on an increment of distance along a length of the first stanchion 102 in order to allow for the setting pin 154 to engage with one of the plurality of locking slots 116-N. The engagement of the setting pin 154 with one of the plurality of locking slots 116-N allows for the roller 106 to be coupled to the first stanchion 102 at the increment of distance associated with the first stanchion apertures 134-N.

The setting pin 154 may have an L-shape including a first leg 156 and a second leg 158 approximately perpendicular to the first leg 156. Each of the locking slots 116-N may include a shape and dimensions that allows for the second leg 158 of the setting pin 154 to engage with the locking slots 116-N as the first leg 156 of the setting pin 154 engages with one of the first stanchion apertures 134-N defined in the and the first stanchion 102 and at least one second stanchion aperture 148-N defined in the second stanchion 104 as described herein in more detail.

The shape and dimensions of the locking slots 116-N may have a first portion located at the opening of the locking slots 116-N that is relatively narrower than a seating surface formed at a terminus of the locking slots 116-N. As depicted in FIGS. 1 through 15, the locking slots 116-N may include a first surface 118-N (where N is any integer greater than or equal to 1) extending from an opening of the locking slots 116-N. Further, the locking slots 116-N may include a second surface 120-N (where N is any integer greater than or equal to 1) extending from the opening of the locking slots 116-N opposite the first surface 118-N. The locking slots 116-N may further include a seating surface formed in a terminus of the locking slots 116-N. The seating surface may be defined by a third surface 122-N (where N is any integer greater than or equal to 1) formed past the first surface 118-N and on the same side of the first surface 118-N, and a fourth surface 124-N (where N is any integer greater than or equal to 1) opposite the third surface 122-N and formed past the second surface 120-N and on the same side of the second surface 120-N. As identified by a first distance 126-N (where N is any integer greater than or equal to 1) defining a distance between the third surface 122-N and the fourth surface 124-N and a second distance 128-N (where N is any integer greater than or equal to 1) defining a distance between the first surface 118-N and the second surface 120-N, the first distance 126-N may be longer than the second distance 128-N. Since the first distance 126-N is longer than the second distance 128-N, allows for the second leg 158 of the setting pin 154 to be seated within the seating surface between the third surface 122-N and the fourth surface 124-N and retained within the locking slots 116-N by the relatively narrower second distance 128-N between the first surface 118-N and the second surface 120-N. In this manner, as a user seeks to engage and disengage the second leg 158 of the setting pin 154 with the locking slots 116-N, the user will have to overcome the relatively narrower space between the first surface 118-N and the second surface 120-N. Further, because a mass may be applied to the roller 106 and the setting pin 154 while the second leg 158 of the setting pin 154 is engaged with the locking slots 116-N the mass may cause the second leg 158 of the setting pin 154 to remain seated in the seating surface between the third surface 122-N and the fourth surface 124-N and retained within the locking slots 116-N without some force applied by the user to disengage the second leg 158 of the setting pin 154 from the seating surface.

The first stanchion 102 may further include indicia located juxtaposition the locking slots 116-N and first stanchion aperture 134-N to indicate the increments. In one example, the indicia may include numerical indicia 130-N (where N is any integer greater than or equal to 1) identifying a measurement along a length of the first stanchion 102 that representing the increments. In one example the numerical indicia 130-N may be placed along a length of the first stanchion 102 based on a bottom surface of the base 108 such that the numerical indicia 130-N indicate a distance from a surface on which the toolless, adjustable pipe support 100 sits. In one example, the numerical indicia 130-N may indicate inches, millimeters, or other unit of measure from the surface on which the pipe support 100 sits.

Further, in one example, the indicia may include at least one linear measurement marking 132-N (where N is any integer greater than or equal to 1) defined along a length of the first stanchion 102. The linear measurement markings 132-N may indicate, along with the numerical indicia 130-N, the measurement along a length of the first stanchion 102 and/or fractions thereof. In the example depicted in FIGS. 1-15, the numerical indicia 130-N and the linear measurement markings 132-N may indicate half inch or quarter inch increments along the length of the first stanchion 102. The first stanchion apertures 134-N may include five, first stanchion apertures 134-N within an inch spacing including one at a first inch mark, one between the first inch mark and a half-inch mark (e.g., at a quarter-inch mark), one at the half-inch mark, one between the half-inch mark and a second inch mark (e.g., at a second quarter-inch mark), and one at the second inch mark. In this manner, the setting pin 154 (along with the roller 106 engaged therewith) may be engaged with the first stanchion apertures 134-N defined in the first panel 110 of the first stanchion 102 and engaged with a corresponding second stanchion aperture 148-N defined in the second stanchion 104 to place the roller 106 at these incremental heights along the length of the first stanchion 102 and the second stanchion 104. In other words, the setting pin 154 and the roller 106 may be engaged at any quarter-inch increment along the length of the first stanchion 102 and the second stanchion 104. However, other increments and measurements may be defined by the locations of the first stanchion apertures 134-N, the second stanchion apertures 148-N, and/or the locking slots 116-N. The locations and types of indicia including the numerical indicia 130-N and the linear measurement marking 132-N may be based on the locations of the first stanchion apertures 134-N, the second stanchion aperture 148-N, and/or the locking slots 116-N.

The second stanchion 104 may be located opposite the first stanchion 102 with respect to the roller 106. The second stanchion 104 may include a third panel 140 and a fourth panel 142 formed approximately perpendicularly to the third panel 140. Further, the second stanchion 104 may include a second stanchion base 146 to couple the second stanchion 104 to the base 108. Still further, the second stanchion 104 may include a second tab 150 used to orient and secure the second stanchion 104 to the base 108. In one example, the third panel 140, the fourth panel 142, the second stanchion base 146, and the second tab 150 may be monolithically formed form a single piece of material such as a metal or metal alloy sheet that has been cut, bent, or otherwise formed in the shape depicted in FIGS. 1 through 15. The third panel 140, the fourth panel 142, and the second stanchion base 146, may be perpendicular with respect to one another in order to form a structurally rigid, weight bearing pipe support 100. The second tab 150 may extend from the bottom of the second stanchion 104 in order to engage with the base 108 as will be described in more detail herein.

The second stanchion 104 may include at least one second stanchion aperture 148-N (where N is any integer greater than or equal to 1) defined in a third panel 140 of the second stanchion 104. As depicted in FIGS. 1 through 15, a plurality of second stanchion apertures 148-N may be defined in the third panel 140. Further, a described herein in more detail, the location of the plurality of second stanchion apertures 148-N may be defined based on an increment of distance along a length of the second stanchion 104 in order to allow for the roller 106 to be coupled to the second stanchion 104 via the setting pin 154 at the increment of distance. In one example, the increments of distance may be the same as the increments of distance defined with respect to the first stanchion 102 so that the roller 106 may be level with respect to the pipe support 100 and a surface on which the pipe support 100 is positioned. In one example, the increments may be defined based on a unit of measurement such as inches or millimeters.

The third panel 140 and/or the fourth panel 142 of the second stanchion 104 may include at least one indicia located juxtaposition the second stanchion apertures 148-N defined on the third panel 140 of the second stanchion 104 that indicate the increments. In one example, the indicia may include numerical indicia or, as depicted in FIGS. 1 through 15, at least one linear measurement marking 144-N (where N is any integer greater than or equal to 1). In one example, the second stanchion 104 may include the numerical indicia 130-N as described above in connection with the first stanchion 102. The linear measurement markings 144-N may be placed along a length of the second stanchion 104 based on a bottom surface of the base 108 such that the linear measurement marking 144-N indicate a distance from a surface on which the toolless, adjustable pipe support 100 sits. In one example, the linear measurement marking 144-N may indicate inches, millimeters, or other unit of measure from the surface on which the pipe support 100 sits. The linear measurement markings 144-N may indicate the measurement along a length of the second stanchion 104 and/or fractions thereof. In the example depicted in FIGS. 1-15, the linear measurement markings 144-N may indicate half inch or quarter inch increments along the length of the second stanchion 104. The second stanchion apertures 148-N may include five, second stanchion apertures 148-N within an inch spacing including one at a first inch mark, one between the first inch mark and a half-inch mark (e.g., at a quarter-inch mark), one at the half-inch mark, one between the half-inch mark and a second inch mark (e.g., at a second quarter-inch mark), and one at the second inch mark. In this manner, the setting pin 154 (along with the roller 106 engaged therewith) may be engaged with the second stanchion apertures 148-N defined in the third panel 140 of the second stanchion 104 and engaged with a corresponding first stanchion aperture 134-N defined in the first stanchion 102 to place the roller 106 at these incremental heights along the length of the first stanchion 102 and the second stanchion 104. In other words, the setting pin 154 and the roller 106 may be engaged at any quarter-inch increment along the length of the first stanchion 102 and the second stanchion 104. However, other increments and measurements may be defined by the locations of the first stanchion apertures 134-N, the second stanchion apertures 148-N, and/or the locking slots 116-N. The locations and types of indicia including the linear measurement marking 144-N may be based on the locations of the first stanchion apertures 134-N, the second stanchion aperture 148-N, and/or the locking slots 116-N.

The base 108 may include at least one reinforcement 166. The reinforcement 166 may include any number of protrusions extending from a portion of the base 108. The reinforcement 166 may serve to create strength along a surface of the base 108. In one example, the base 108 may not include the reinforcement 166. In one example, the base 108 may include the reinforcement 166 that is formed on different parts of the base 108 than those depicted in FIGS. 1 through 15 and/or having a different shape than that depicted in FIGS. 1 through 15. In one example, the reinforcement 166 may be monolithically formed with the base 108.

The base 108 may further include a first mount 162 and a second mount 164. The first mount 162 and the second mount 164 may be used to couple the first stanchion 102 and the second stanchion 104 to the base 108. In one example, the first stanchion base 136 of the first stanchion 102 and the second stanchion base 146 of the second stanchion 104 may include apertures defined therein through which fastening devices may extend through and into the first mount 162 and a second mount 164 of the base 108 in order to couple the first stanchion 102 and the second stanchion 104 to the base 108. In one example, the fastening devices May include a first bolt 180 and/or a first washer 182 to couple the first stanchion base 136 to the first mount 162 and a second bolt 184 and/or a second washer 186 to couple the second stanchion base 146 to the second mount 164. In one example, the first stanchion base 136 and second stanchion base 146 may include an aperture located where the first bolt 180 and/or the first washer 182 and the second bolt 184 and/or the second washer 186 may enter the first mount 162 and the second mount 164, respectively. Further, in one example, the underside of the first mount 162 and the second mount 164 may be hollow, and nuts (not shown) may engage with the first bolt 180 and second bolt 184, respectively to secure the first stanchion base 136 to the first mount 162 and the second stanchion base 146 to the second mount 164, respectively.

The first mount 162 and the second mount 164 may include features to assist in orienting and securing the first stanchion 102 to the first mount 162 of the base 108 and the second stanchion 104 to the second mount 164 of the base 108. The first mount 162 may include a first protrusion 168, a second protrusion 170, and a first recess 172 defined in the first mount 162 between the first protrusion 168 and the second protrusion 170. Similarly, the second mount 164 may include a third protrusion 174, a fourth protrusion 176, and a second recess 178 defined in the second mount 164 between the third protrusion 174 and the fourth protrusion 176. As mentioned above, the first stanchion 102 may include the first tab 138 that extends below the first stanchion base 136 of the first stanchion 102 and the second stanchion 104 may similarly include the second tab 150 that extends below the second stanchion base 146 of the second stanchion 104. In one example, the first recess 172 may be dimensioned to allow the first tab 138 to fit within the first recess 172. Further, the first protrusion 168 and the second protrusion 170 may form sidewalls around the first tab 138 so that the first tab 138 may be seated between the first protrusion 168 and the second protrusion 170 and within the first recess 172. Similarly, in one example, the second recess 178 may be dimensioned to allow the second tab 150 to fit within the second recess 178. Further, the third protrusion 174 and the fourth protrusion 176 may form sidewalls around the second tab 150 so that the second tab 150 may be seated between the third protrusion 174 and the fourth protrusion 176 and within the second recess 178. In this manner, the first stanchion 102 and the second stanchion 104 may be oriented and secured to the first mount 162 and the second mount 164 of the base 108.

Having described the various features of the base 108, in one example, the base 108 including the reinforcement 166, the first mount 162, the second mount 164, the first protrusion 168, the second protrusion 170, the first recess 172, the third protrusion 174, the fourth protrusion 176, and/or the second recess 178 may be monolithically formed through any manufacturing process including, for example, thermoforming, three-dimensional (3D) printing, and other manufacturing processes. In one example, the base 108 including the reinforcement 166, the first mount 162, the second mount 164, the first protrusion 168, the second protrusion 170, the first recess 172, the third protrusion 174, the fourth protrusion 176, and/or the second recess 178 of the base 108 may be formed separately and coupled together.

The roller 106 may be coupled between the first stanchion 102 and the second stanchion 104 by extending the setting pin 154 through a bore 1602 (FIGS. 16 and 18) defined in a longitudinal axis of the roller 106. For example, a user may extend the setting pin 154 through one of the first stanchion apertures 134-N of the first stanchion 102, through the bore 1602 of the roller 106, and through a corresponding one of the second stanchion apertures 148-N of the second stanchion 104. Once the setting pin 154 is engaged with the first stanchion 102, roller 106, and second stanchion 104 in this manner, a spring cotter pin 160 may be engaged with the setting pin 154 to secure the setting pin 154 within the toolless, adjustable pipe support 100 by restricting the ability to pull the setting pin 154 out of engagement with the toolless, adjustable pipe support 100. In one example, the setting pin 154 may include an annular groove 1902 as depicted in FIG. 19 defined in the second leg 158 of the setting pin 154. The spring cotter pin 160 may engage with the setting pin 154 by being seated within the annular groove 1902.

The roller 106 may include any shape and, in one example, may a parabolic surface 152. The parabolic surface 152 allows for a pipe or similar infrastructure element to be seated on the roller without falling off a side of the roller 106 and/or the toolless, adjustable pipe support 100. However, the roller 106 may have any shape to accommodate any application or item of infrastructure placed thereon. Further, the roller 106 may freely rotate about the second leg 158 of the setting pin 154 in order to allow for the piping or other infrastructure element to roll across the top of the roller 106 as the materials (e.g., metals and metal alloys) from which the piping or other infrastructure element are made expand and contract due to changes in ambient temperature.

The toolless, adjustable pipe support 100 may be adjusted without the use of tools. As depicted in the different configurations in, for example, FIGS. 12 through 15 as compared to FIGS. 1 through 11, the toolless, adjustable pipe support 100 may be adjusted to move the roller 106 along the length of the first stanchion 102 and the second stanchion 104. In order to do so, the spring cotter pin 160 may be disengaged from the annular groove 1902 of the second leg 158 of the setting pin 154. The setting pin 154 may then be disengaged from the locking slot 116-N that it is currently engaged with and pulled out of the second stanchion apertures 148-N of the second stanchion 104, the bore 1602 of the roller 106, and the first stanchion apertures 134-N of the first stanchion 102 to free the setting pin 154 from the toolless, adjustable pipe support 100. This causes the roller 106 to also become freed from the toolless, adjustable pipe support 100. The user may then determine a height at which the user desires to place the roller 106 by consulting the numerical indicia 130-N and/or the linear measurement markings 132-N placed on the first stanchion 102 and linear measurement markings 144-N placed on the second stanchion 104. Once such a determination has been made, the user may then engage the setting pin 154 at the desired height by inserting the first leg 156 of the setting pin 154 into the desired first stanchion apertures 134-N of the first stanchion 102, through the bore 1602 defined in the roller 106, and through a second stanchion aperture 148-N of the second stanchion 104 that corresponds to the first stanchion apertures 134-N of the first stanchion 102. The second leg 158 may be engaged with one of the locking slots 116-N that the second leg 158 may engage with. It may be noted here that the locking slot 116-N that the second leg 158 may engage with may be determined based at least in part on the first stanchion apertures 134-N and corresponding second stanchion aperture 148-N that the first leg 156 is engaged with. The user may ensure that the second leg 158 is seated in the seating surface between the third surface 122-N and the fourth surface 124-N of the locking slot 116-N in order to make sure that the second leg 158 of the setting pin 154 does not become disengaged from the locking slot 116-N. The user may then engage the spring cotter pin 160 with the annular groove 1902 of the second leg 158 of the setting pin 154 to ensure that the setting pin 154 cannot be unintentionally removed from the toolless, adjustable pipe support 100. In this manner, the location of the roller 106 may be quickly and easily adjusted without the use of tools.

### CONCLUSION

The examples described herein provide a toolless, adjustable pipe support that includes a roller that may be quickly and easily adjusted along a height of the toolless, adjustable pipe support without the use of any tools. Because the toolless, adjustable pipe support does not require tools and is lightweight and can be easily carried to, for example, a rooftop of a structure, a user may more quickly and easily install the toolless, adjustable pipe support.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure, and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A pipe support comprising:
a first stanchion comprising a first aperture defined in the first stanchion;
a second stanchion comprising:
a second aperture defined in the second stanchion; and
a locking slot defined in the second stanchion; and
a setting pin comprising a first leg and a second leg,
wherein:
the first leg engages with the first aperture and the second aperture, and
the second leg engages with the locking slot to lock the setting pin in an engaged state.

2. The pipe support of claim 1, further comprising a roller coupled to the first leg of the setting pin.

3. The pipe support of claim 1, further comprising a base coupled to at least one of the first stanchion or the second stanchion.

4. The pipe support of claim 1, wherein:
the first aperture comprises a plurality of first apertures defined in the first stanchion, and
the second aperture comprises a plurality of second apertures defined in the second stanchion.

5. The pipe support of claim 4, wherein the plurality of first apertures and the plurality of second apertures are defined at increments along a length of the first stanchion and the second stanchion, respectively.

6. The pipe support of claim 5, wherein the increments are defined based on a unit of measurement.

7. The pipe support of claim 6, further comprising indicia located juxtaposition the increments, the indicia representing the increments.

8. The pipe support of claim 4, wherein:
the locking slot comprises a plurality of locking slots defined in the second stanchion,
the plurality of locking slots are defined at increments along a length of the second stanchion, and
the increments are defined based at least in part on locations of the plurality of first apertures and the plurality of second apertures.

9. The pipe support of claim 1, wherein the locking slot comprises:
a first surface extending from an opening of the locking slot;
a second surface extending from the opening of the locking slot opposite the first surface; and
a seating surface formed in a terminus of the locking slot,
wherein a distance between the first surface and the second surface is less than a width of the seating surface.

10. The pipe support of claim 9, wherein the first surface and the second surface retain the second leg of the setting pin within the seating surface formed in the terminus of the locking slot.

11. A pipe support comprising:
a first stanchion comprising a first aperture defined in the first stanchion; and
a second stanchion comprising:
a second aperture defined in the second stanchion; and
a locking slot defined in the second stanchion.

12. The pipe support of claim 11, further comprising:
an setting pin comprising:
a first leg to engage with the first aperture and the second aperture; and
a second leg to engage with the locking slot to lock the setting pin in an engaged state; and
a roller coupled to the first leg of the setting pin.

13. The pipe support of claim 11, further comprising a base coupled to at least one of the first stanchion or the second stanchion.

14. The pipe support of claim 11, wherein:
the first aperture comprises a plurality of first apertures defined in the first stanchion, and
the second aperture comprises a plurality of second apertures defined in the second stanchion.

15. The pipe support of claim 14, wherein the plurality of first apertures and the plurality of second apertures are defined at increments along a length of the first stanchion and the second stanchion, respectively.

16. The pipe support of claim 15, wherein the increments are defined based on a unit of measurement.

17. The pipe support of claim 16, further comprising indicia located juxtaposition the increments, the indicia representing the increments.

18. The pipe support of claim 14, wherein:
the locking slot comprises a plurality of locking slots defined in the second stanchion,
the plurality of locking slots are defined at increments along a length of the second stanchion, and
the increments are defined based at least in part on locations of the plurality of first apertures and the plurality of second apertures.

19. The pipe support of claim 12, wherein the locking slot comprises:
a first surface extending from an opening of the locking slot;
a second surface extending from the opening of the locking slot opposite the first surface; and
a seating surface formed in a terminus of the locking slot,
wherein a distance between the first surface and the second surface is less than a width of the seating surface.

20. The pipe support of claim 19, wherein the first surface and the second surface retain the second leg of the setting pin within the seating surface formed in the terminus of the locking slot.
